(19) United States
(12) Patent Application Publication
(10) Pub. No.: US 2023/0313573 A1
(43) Pub. Date: Oct. 5, 2023

(54) VEHICLE COMPARTMENT LATCH

(71) Applicant: Rivian IP Holdings, LLC, Plymouth, MI (US)

(72) Inventors: Marcus Merideth, Westland, MI (US); Thomas Young, Costa Mesa, CA (US); Kosta Papanikolaou, Corona, CA (US); David Boyer, Irvine, CA (US); Joshua Rogers, Murrieta, CA (US)

(21) Appl. No.: 17/710,447

(22) Filed: Mar. 31, 2022

(51) Int. Cl. E05B 83/26; E05B 83/18; E05B 85/26; E05B 77/54

(52) U.S. Cl. CPC E05B 83/26; E05B 83/18; E05B 85/26; E05B 77/54; E05B 85/243

(57) ABSTRACT

Disclosed embodiments include apparatuses, vehicles, and methods for managing operation of a latch securing a vehicle compartment hatch. In an illustrative embodiment, an apparatus includes a primary latch that defines a slot configured to receive a striker extending from the hatch and is rotatable between a locked position where the slot is oriented to hold the striker to retain the hatch in a closed position and an unlocked position in which the slot is oriented to enable the striker to be withdrawn from the slot to permit opening of the hatch; and a secondary latch mechanism configured to be moved between: a first configuration configured to maintain the primary latch in the closed position; a second configuration configured to enable the striker to move within the slot to permit partial opening of the hatch; and a third configuration configured to enable the primary latch to rotate to the unlocked position.

### INTRODUCTION

Vehicle compartments, such as rear trunks or front compartments (which may be included in electrically-powered or rear engine vehicles) may be equipped with safety releases so that a person trapped inside the compartment can release the latch that secures the compartment hatch. Opening the compartment hatch while a vehicle is moving may present a safety concern, particularly with compartments at the front of a vehicle: if the safety release is activated while the vehicle is moving, the open compartment hatch may obstruct an operator's vision and, thus, lead to an accident.

The statements in this section merely provide background information related to the present disclosure and may not constitute prior art.

### SUMMARY

Disclosed embodiments include apparatuses, vehicles, and methods for managing operation of a latch securing a compartment hatch so that activation of a safety release within the compartment only enables partial opening of a compartment hatch (to permit airflow into the compartment) unless or until the vehicle is traveling at or below a threshold speed when it is safe for the compartment hatch to open.

In an illustrative embodiment, an apparatus includes a primary latch that defines a slot configured to receive a striker extending from a compartment hatch and that is rotatable between a locked position in which the slot is oriented to hold the striker to retain the compartment hatch in a closed position and an unlocked position in which the slot is oriented to enable the striker to be withdrawn from the slot to permit opening of the compartment hatch; and a secondary latch mechanism configured to be moved between: a first configuration configured to maintain the primary latch in the closed position; a second configuration configured to enable the striker to move within the slot to permit partial opening of the hatch; and a third configuration configured to enable the primary latch to rotate to the unlocked position.

In another illustrative embodiment, a vehicle includes a vehicle body that defines at least one compartment closable by a compartment hatch; a primary latch that defines a slot configured to receive a striker extending from a compartment hatch and that is rotatable between a locked position in which the slot is oriented to hold the striker to retain the compartment hatch in a closed position and an unlocked position in which the slot is oriented to enable the striker to be withdrawn from the slot to permit opening of the compartment hatch; and a secondary latch mechanism configured to be moved between: a first configuration configured to maintain the primary latch in the closed position; a second configuration configured to enable the striker to move within the slot to permit partial opening of the hatch; and a third configuration configured to enable the primary latch to rotate to the unlocked position.

In another illustrative embodiment, a method includes providing a vehicle with a compartment hatch configured to close a compartment and including a striker; providing a primary latch within the compartment that is configured to receive the striker and is rotatable between a locked position in which the primary latch is oriented to hold the striker to retain the compartment hatch in a closed position and an unlocked position in which the primary latch is oriented to enable the striker to be withdrawn from the primary latch to permit opening of the compartment hatch; and providing a secondary latch mechanism configured to be moved between: a first configuration configured to maintain the primary latch in the closed position; a second configuration configured to enable the primary latch to move to an intermediate position between the locked position and the unlocked position to permit partial opening of the hatch; and a third configuration configured to enable the primary latch to rotate to the unlocked position.

Further features, advantages, and areas of applicability will become apparent from the description provided herein. It will be appreciated that the description and specific examples are intended for purposes of illustration only and are not intended to limit the scope of the present disclosure.

### DRAWINGS

The drawings described herein are for illustration purposes only and are not intended to limit the scope of the present disclosure in any way. The components in the figures are not necessarily to scale, with emphasis instead being placed upon illustrating the principles of the disclosed embodiments. In the drawings:

FIG. 1 is side view of a vehicle in partial cutaway equipped with a latch apparatus that restricts opening of a compartment hatch;

FIGS. 2A-2C and 3A-3C are schematic diagrams of embodiments of latch apparatuses including a primary latch that engages a striker extending from a compartment hatch and a secondary latch mechanism to restrict movement of the primary latch;

FIGS. 4 and 5 are schematic views of electrically-powered and gasoline-powered vehicles, respectively, equipped with embodiments of a latch apparatus of FIGS. 2A-2C and 3A-3C; and

FIG. 6 is a flow chart of an illustrative method for providing a latch apparatus with a secondary latch mechanism to control opening of a primary latch.

### DETAILED DESCRIPTION

The following description explains, by way of illustration only and not of limitation, various embodiments. By way of a non-limiting introduction and overview, in various embodiments, an apparatus includes a primary latch for securing a striker extending from a compartment hatch of a vehicle and a secondary latch mechanism for managing operation of the primary latch in response to activation of a safety release within the compartment and/or an external trigger to open the compartment.

The secondary latch mechanism secures the latch mechanism in a closed configuration in which the compartment hatch remains fully closed. However, the secondary latch mechanism enables the primary latch to allow partial opening of the compartment hatch, for example, to enable air to get into the compartment. In various embodiments, the secondary hatch mechanism may include a first latch member that prevents the primary latch from moving from the closed position. However, responsive to activation of the safety release, the secondary latch mechanism (e.g., via movement of the first latch member) enables partial opening of the primary latch. The secondary latch mechanism, such as via a second latch member, prevents the hatch compartment from being opened further unless the vehicle is traveling at or below a threshold speed. Therefore, for example, if the compartment is a front compartment, activation of the safety release will not result in the compartment hatch opening fully while the vehicle is moving (or is only moving slowly) and, thus, possibly obstructing vision of a vehicle operator and creating a safety hazard.

When the vehicle is traveling at or below the threshold speed, the secondary latch mechanism (e.g., via movement of the second latch member) enables the primary latch to fully release the striker to enable the compartment hatch to fully open. In this case, the secondary latch mechanism, in response to activation of the safety release or an external trigger (such as a hatch release) allows the compartment hatch to open.

Now that a general overview has been given, details of various embodiments will be explained by way of non-limiting examples given by way of illustration only and not of limitation.

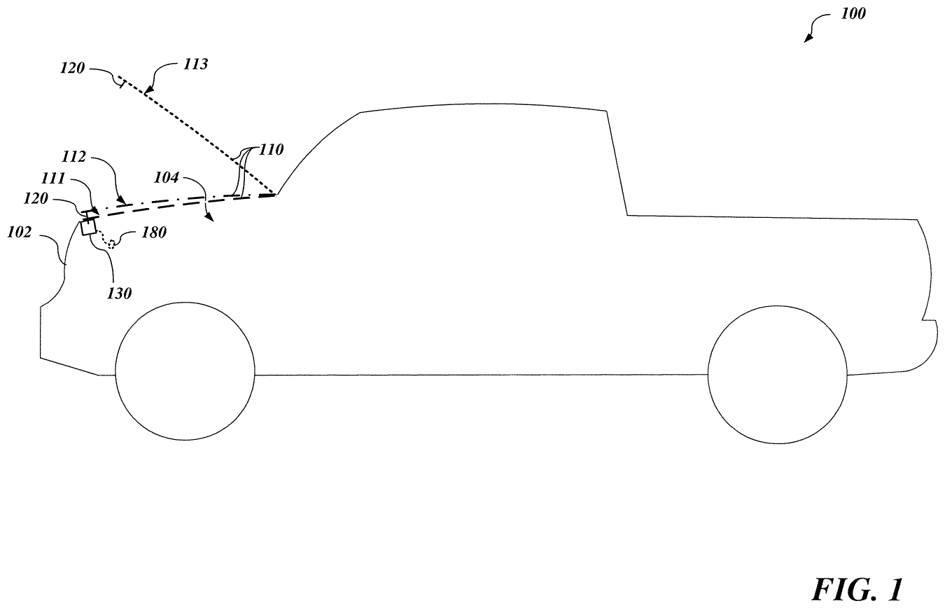

Referring to FIG. 1, a vehicle 100 includes a vehicle body 102 that defines a compartment 104, such as a front compartment at a front 106 of the vehicle 100, that is closable via a compartment hatch 110, such as a hood, trunk like, hatchback, or similar hatch. That compartment hatch 110 includes a striker 120 that extends from the compartment hatch 110 toward the compartment 104 where is received by a latch apparatus 130. In various embodiments, as further described below, the latch apparatus 130 includes a primary latch and a secondary latch mechanism to restrict opening of the compartment hatch 110, as further described below.

In various embodiments, the latch apparatus 130 maintains the compartment hatch 110 in a closed position 111 (represented by a dashed line in FIG. 1) by holding the striker 120 in a closed position. In various embodiments, a secondary latch mechanism of the latch apparatus 130 includes a first latch member that prevents the primary latch from being moved to release the striker 120.

The latch apparatus 130 includes an emergency release 180 disposed inside the compartment 104 that can be used by someone inside the compartment 104 to release the compartment hatch 110. According to various embodiments, when the emergency release 180 is engaged when the vehicle 100 is traveling in excess of a threshold speed, the latch apparatus 130 enable the compartment hatch 110 to open to a partially open position 112 (represented by a dashed and dotted line in FIG. 1). The partially open position 112 may, for example, enable air to flow into the compartment 104. In the partially open position 112, the primary latch enables the striker 120 to move a distance within the latch apparatus 130. However, in various embodiments, a second latch member of the secondary latch mechanism prevents the primary latch from fully releasing the striker 120.

According to various embodiments, as further described below, the second latch member of a secondary latch mechanism (described below) prevents the compartment hatch from opening further until the vehicle 100 is traveling at or below a threshold speed. In various embodiments, the threshold speed may be zero miles per hour, dictating that the vehicle 100 be stopped or traveling at a low speed at which opening of the compartment hatch 110 will not present a hazard before the compartment hatch 110 is permitted to fully open. When the vehicle 100 is traveling at or below the threshold speed, engagement of the emergency release 180 or an external trigger, such as activation of a mechanical or electromechanical hatch release, allows the compartment hatch 110 to open to a fully open position 113 (represented by a dotted line in FIG. 1). In this case, in various embodiments, the second latch member of the secondary latch mechanism is moved to enable the primary latch of the latch apparatus 130 to fully release the striker. When the striker 120 is fully released by the latch apparatus 130, the compartment hatch 110 is able to move to the fully open position 113 (represented by a dotted line in FIG. 1).

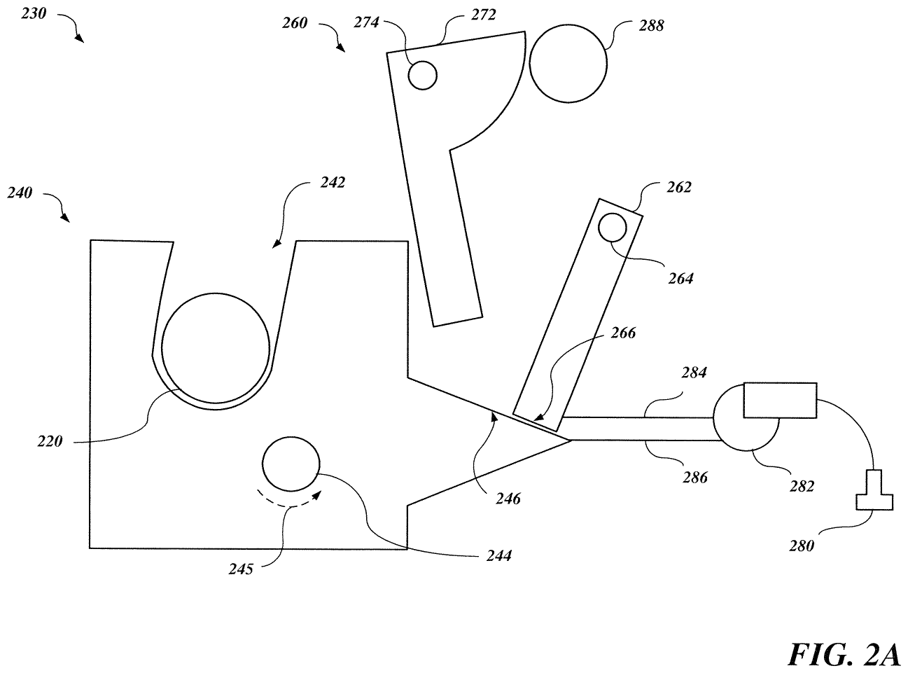

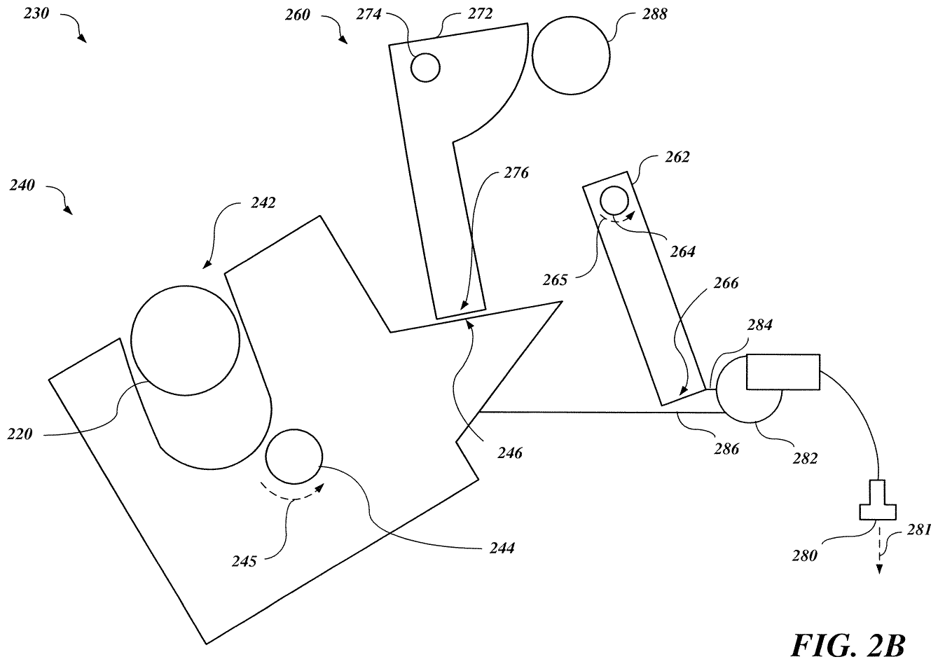

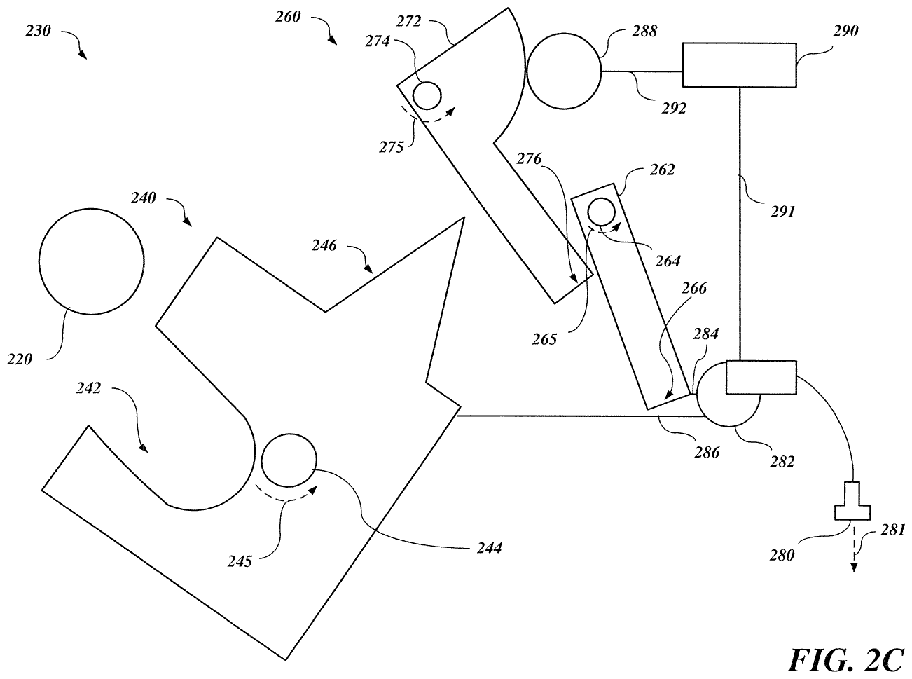

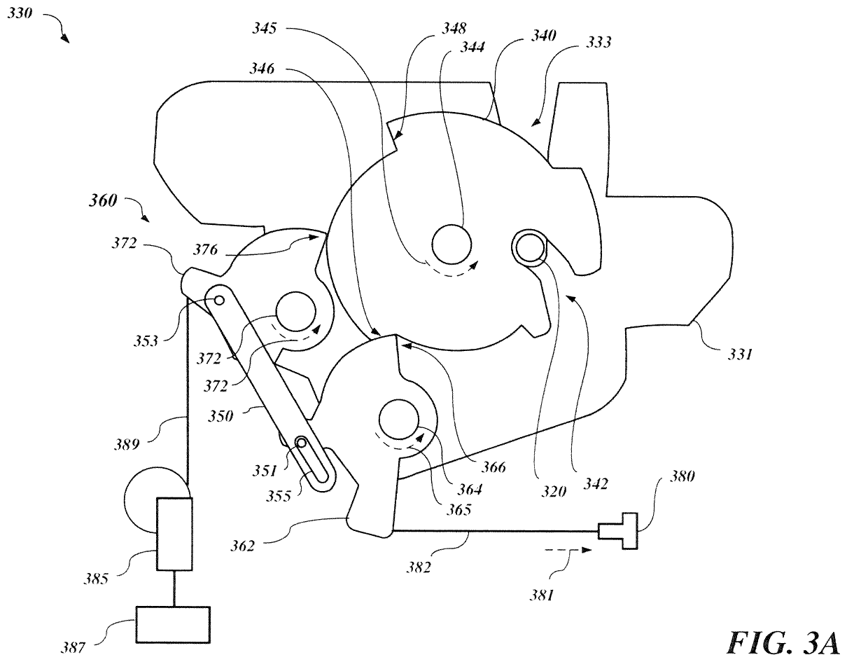

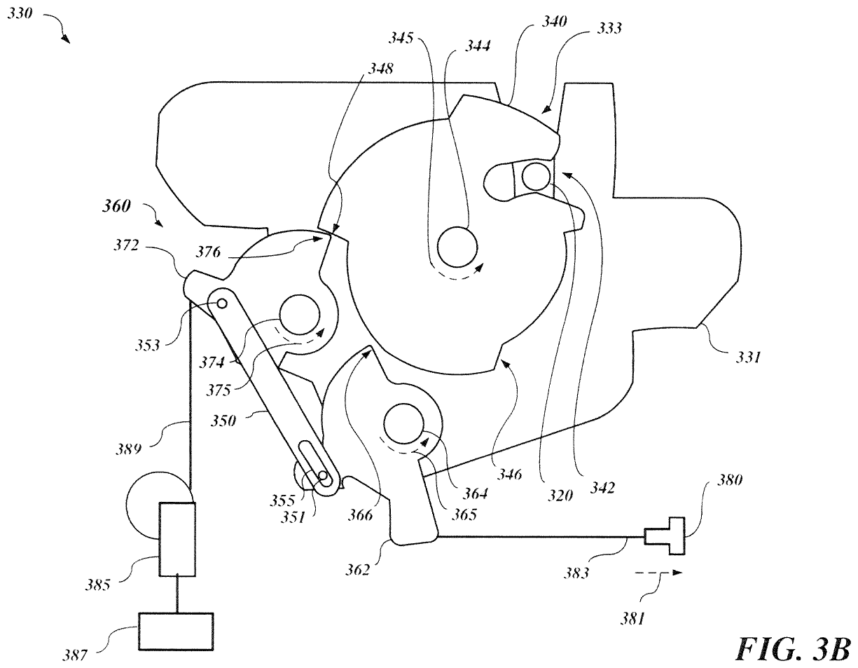

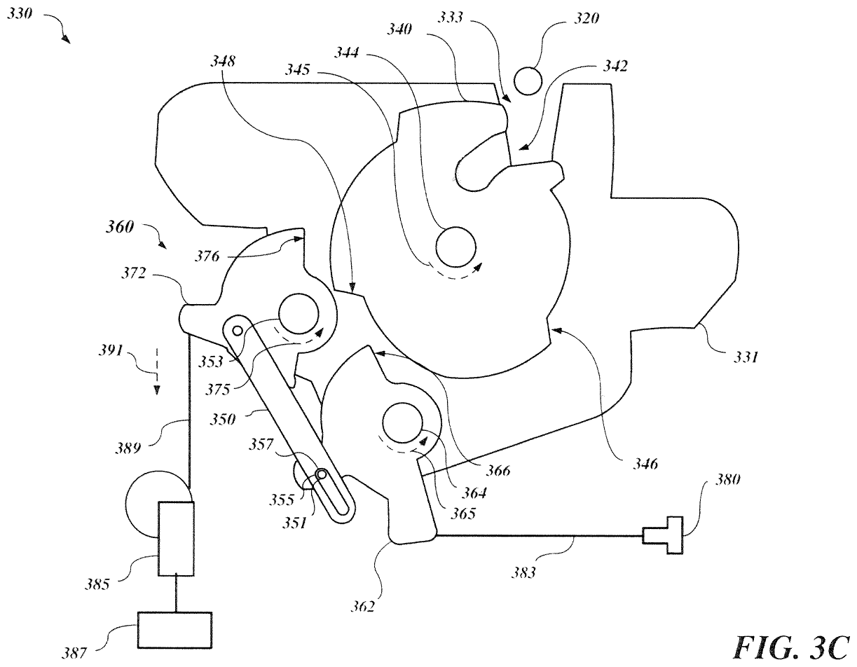

Referring to FIG. 2A, an embodiment of a latch apparatus 230 includes a primary latch 240 and a secondary latch mechanism 260 that are arranged in a locked configuration corresponding with the compartment hatch (not shown in FIG. 2A) being in a closed position. A striker 220 extending from the compartment hatch is received in a slot 242 defined by the primary latch 240. In various embodiments, as described with reference to FIGS. 3A-3C, the primary latch 240 may operate in conjunction with a base plate so that the interoperation of the base plate and the slot 242 secure the striker 220. The primary latch 240 is rotatably mountable about a pivot 244 that may be integrated with or fixably attached to a vehicle body (not shown in FIG. 2A). The primary latch 240 rotates in a first (opening) direction 245 about the pivot 244 to move from the locked position toward an unlocked position, as described further below.

The secondary latch mechanism 260 includes a first latch member 262 rotatably mountable about a first pivot 264 and a second latch member 272 rotatably mounted about a second pivot 274. An emergency release 280 is coupled to a first actuator 282 that is connected by a first linkage 284, such as a cable, with the first latch member 262 and by a second linkage 286, such as a cable, that is connected with the primary latch 240 to direct the movement of each as described below. In various embodiments, a second actuator 288 is mechanically engaged to with the second latch member 272 to direct its movement as described below.

In the locked configuration depicted in FIG. 2A, the first latch member 262 of the secondary latch mechanism 260 prevents the primary latch 240 from rotating out of the locked position. In various embodiments, in the locked position, the first latch member 262 is rotated about the first pivot 264 so that a distal end 266 of the first latch member 262 abuts a locking surface 246 of the primary latch 240. Thus, the first latch member 262 prevents the primary latch 240 from moving in the first (opening) direction 245 and, thus, maintains the primary latch 240 in the locked position in which the compartment hatch (not shown in FIG. 2A) is in a fully closed position.

Referring to FIG. 2B, the emergency release 280 is engaged, such as by moving the emergency release 280 in a first (engaging) direction 281. In the example of FIG. 2B, it is assumed that the vehicle is moving at a speed that is greater than the threshold speed.

Engaging the emergency release 280 activates the first actuator 282. The first actuator 282 motivates the first linkage 284 to cause the first latch member 262 to rotate in a direction 265 about the first pivot 264 which moves the distal end 266 of the first latch member 262 clear of the locking surface 246 of the primary latch 240. The first actuator 282 also motivates the second linkage 286 to enable the primary latch to rotate in the first (opening) direction 245. As a result, the primary latch rotates about the pivot 244 in the first (opening) direction 245, enabling the striker 220 to move within the slot 242.

However, the primary latch 240 is able to rotate in the first (opening) direction 245 only until the locking surface 246 of the primary latch 240 abuts a distal end 276 of the second latch member 272. Because the vehicle is moving in excess of the threshold speed, the second actuator 288 does not move the second latch member 272 and the second latch member 272 blocks further rotation of the primary latch 240. As a result, the compartment hatch 110 (FIG. 1) is permitted to open to the partially open position 112, but is not permitted to open to the fully open position 113. This is referred to herein as an intermediate position. Thus, while the striker 220 is able to move within the slot 242, it is not able to be fully withdrawn from the slot 242. Therefore, as previously described, engagement of the emergency release 280 while the vehicle 100 is moving enables the compartment hatch 110 to open to permit airflow, but not to fully open so as to block the operator's view toward the front 102 of the vehicle 100.

Referring to FIG. 2C, the primary latch 240 rotates to enable the striker 220 to pass out of the slot 242 to enable the compartment hatch 110 of the vehicle 100 to be opened to the fully open position 113 (FIG. 1). In various embodiments, the compartment hatch 110 may be fully opened when (1) the emergency release 280 is engaged and the vehicle 100 is traveling at a speed at or below the threshold speed; or (2) the vehicle 100 is stopped and an external trigger 290, such as a mechanical hatch release or an electromechanical hatch release coupled to the first actuator 282 and the second actuator 288, is activated. The second actuator 288 motivates the second latch member 272 to rotate in a direction 275 about the second pivot 274 which moves the distal end 276 of the second latch member 272 clear of the locking surface 246 of the primary latch 240. As a result, the primary latch 240 is free to rotate in the first (opening) direction 245 about the pivot 244, and the striker 220 is able to move out of the slot 242 to allow the compartment hatch 110 to be opened to the fully open position 113. Thus, this configuration is configured to enable the primary latch 240 to rotate to an unlocked position.

Referring to FIGS. 3A-3C, a latch apparatus 330 includes a secondary latch mechanism 360 that includes a first pawl latch 362 and a second pawl latch 372 that are used to restrict opening of a primary latch 340. In the embodiments of FIGS. 3A-3C, the latch apparatus 330 includes a base plate 331 to which the primary latch 340 is rotatably mounted about a pivot 344. The base plate 331 defines a channel 333 where a striker 320 extending from a compartment hatch (not shown in FIGS. 3A-3C) is received. When the primary latch 340 is in a closed position, such as shown in FIG. 3A, a slot 342 defined by the primary latch 340 is rotated to secure the striker 342 within the channel 333 and the slot 342.

The pawl latches 362 and 372 are configured to selectively engage notches 346 and 348, respectively, on the primary latch to selectively prevent the primary latch 340 from rotating in an opening direction 345 which moves the slot 342 to enable the striker to pass out of the channel 333, as further described below. In various embodiments, the pawl latches 362 and 372 are biased by springs or similar mechanisms to rotate the pawl latches 362 and 372 to engage the primary latch 340, as further described below.

In the closed position shown in FIG. 3A, a first protrusion 366 on the first pawl latch 362 engages a first notch 346 on the primary latch 340. With the first protrusion 366 engaging the first notch 346, the primary latch 340 is prevented from rotating in the opening direction 345. Thus, the slot 342 in the primary latch 340 maintains the striker 320 within the channel 333 in the base plate 331.

The first pawl latch 362 may be rotated about a first pivot 364 in a first direction 365 by engaging an emergency release 380 that is coupled to the primary pawl latch 362 by a linkage 382, such as a cable. In cases in which the primary pawl latch 362 is biased by a spring, the primary pawl latch 362 may be biased in a direction opposite to the first direction 365, but the bias may be overcome by engaging the emergency release 380. Moving the emergency release 380 in a direction 381 causes the first pawl latch 362 to rotate in the first direction 365 and move the first protrusion 366 away from the first notch 346 in the primary latch 340, enabling the primary latch 340 to rotate in the opening direction 345.

As will be further described below, the pawl latches 362 and 372 are engaged by a slidable linkage 350. A first pin 351 extends from the first pawl latch 362 into a slot 355 on the sliding linkage 350 where the first pin 351 is slidably and rotatably received. A second pin 353 extends from the second pawl latch 372 and is rotatably received by the sliding linkage 350. As will be appreciated, when the first pawl latch 362 is rotated in the first direction 365, the first pin 351 is able to move within the slot 355 so that the first pawl latch 362 may be rotated in the first direction 365 without the second pawl latch 372 being rotated.

Referring to FIG. 3B, with the first pawl latch 362 rotated in the first direction 365, the first protrusion 366 is withdrawn from the first notch 346 on the primary latch 340, enabling the primary latch 340 to rotated in the opening direction 345. As a result of the rotation of the primary latch 340, the slot 342 also rotates relative to the base plate 331 which allows the striker 320 to move within the slot 342 and the channel 333. As a result, the compartment hatch (not shown) may partially open. This is again referred to herein as an intermediate position.

However, the movement of the emergency release 380 described with reference to FIG. 3A does not rotate the second pawl latch 372. As a result, the primary latch 340 is able to rotate in the opening direction 345 until the second notch 348 on the primary latch 340 abuts the second protrusion 376 extending from the second pawl latch 372. Thus, while the movement of the first pawl latch 362 enabled the compartment hatch to partially open, the second pawl latch 372 arrests further rotation of the primary latch 340 and, thus, prevents the compartment hatch from fully opening.

In the example shown, opening the compartment hatch requires that an actuator 385 be engaged by an external trigger 387, which may be a mechanical or electromechanical switch (which may be remotely activated), which may include a key latch, a release cable, a motor, or another device. The actuator 385 is coupled to the second pawl latch 372 by a release linkage 389 such that, when the external trigger 387 engages the actuator 385, the release linkage 389 causes the second pawl latch 372 to rotate in a second direction 375 to enable movement of the primary latch, as further described below.

Referring to FIG. 3C, activation of the actuator 385 results in the release linkage 389 moving a direction 391 to rotate the second pawl latch 372 in the second direction 375. Rotating the second pawl latch 372 in the second direction 375 moves the second protrusion 376 away from the second notch 348 in the primary latch 340, enabling the primary latch to rotate in the opening direction 345. As a result of the rotation of the primary latch 340, the slot 342 is rotated relative to the channel 333 in the base plate 331 so that the striker 320 may be withdrawn from the channel 333 and the slot 342, enabling the compartment hatch to open fully. Thus, this configuration is configured to enable the primary latch 340 to rotate to an unlocked position.

It will be appreciated that, when the actuator 385 is engaged to rotate the second pawl latch 372 in the second direction 375, the linkage 350 will also cause the first pawl latch 362 to rotate in the first direction 365. When the second pawl latch 372 rotates in the second direction, the pin 353 drives the slidable linkage 350 toward the first pin 351. A trailing end 357 of the slot 355 (which enables the first pawl latch 362 to move independently, as described with reference to FIG. 3B) engages the first pin 351, causing the first pawl latch 362 to rotate in the first direction 365. As previously described, rotation of the pawl latches 362 and 372 moves both protrusions 366 and 376 away from both notches 346 and 348, respectively, allowing the primary latch 340 to rotate in the opening direction 345. Thus, the actuator 385, when activated by the external trigger 387, enables the primary latch 340 to be opened to the fully open position 113 (FIG. 1) without engagement of the emergency release 380 and/or without a separate actuator rotating the first pawl latch 362.

In various embodiments, the latch apparatuses 230 and 330 may be used with any number of vehicles and may be used with any hatch—front, rear, side, or otherwise—for which a partial, but not full opening may be desired. In various embodiments, the latch apparatuses 230 and 330 may be integrated into a vehicle such as a car, truck, sport utility vehicle, van, or recreational vehicle. In various embodiments, the vehicle also may include a motorcycle, all-terrain vehicle, or an electrically-powered moped or bicycle. In various embodiments, the vehicle also may include a marine vessel (such as a boat or a ship). In various embodiments, the vehicle also may include an aircraft (such as fixed-wing aircraft, rotary wing aircraft, and lighter-than-air craft).

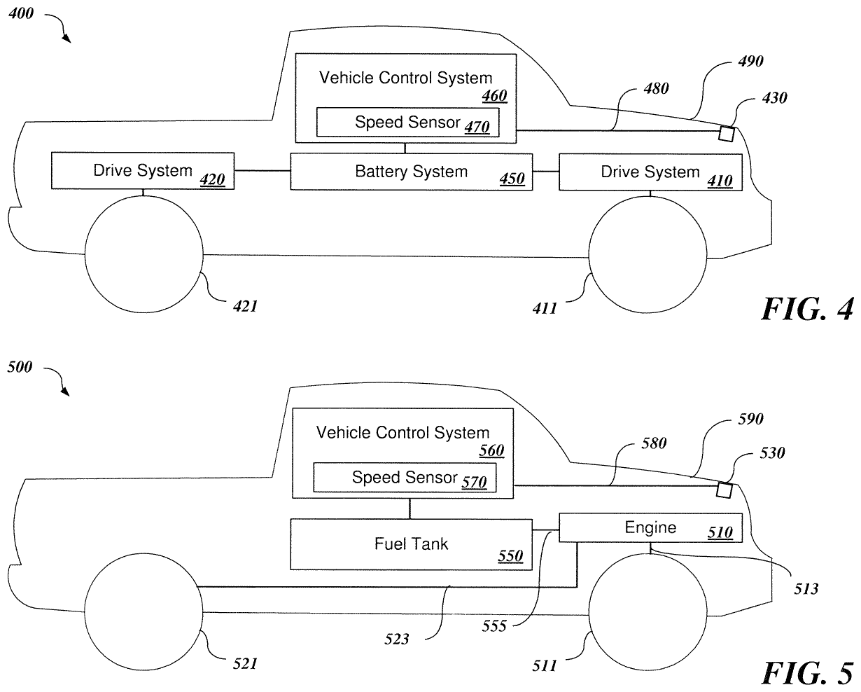

By way of example, referring to FIG. 4, a vehicle 400 includes an electrically-powered land vehicle. The vehicle 400 includes one or more drive systems 410 and 420 that drive associated wheels 411 and 421, respectively. The drive systems 410 and 420 draw power from a battery system 450. The vehicle 400 is equipped with a latch apparatus 430 that, in various embodiments, may include a latch apparatus 230 (FIGS. 2A-2C) or latch apparatus 330 (FIGS. 3A-3C). In various embodiments, the latch apparatus 430 is in communication with a vehicle control system 460. The vehicle control system 460 may integrate controls to permit local or remote activation of the latch apparatus 430 to control opening of a compartment hatch 490.

As previously described, the latch apparatus 430 may be used to enable a compartment hatch 490 to be partially opened to permit airflow into a compartment closable by the compartment hatch 490 unless the vehicle 400 is traveling at or below a threshold speed to, for example, prevent the compartment hatch 490 from opening and blocking the view of an operator when the vehicle 400 is not stopped or cannot be immediately stopped. To this end, a speed sensor 470 (which may be part of the vehicle control system 460 or may be a separate device) communicates via a physical or communicative connection 480. Thus, for example, if the vehicle 400 is traveling in excess of the threshold speed when an emergency release (not shown in FIG. 4) is engaged, a secondary latch mechanism 260, 360 as described with reference to FIGS. 2A-2C and 3A-3C may prevent a primary latch from fully opening and thereby prevent the compartment hatch 490 from fully opening.

Referring to FIG. 5, a gas-powered vehicle 500 also may include an embodiment of the latch apparatus 530. The vehicle 500 includes an engine 510 that drives wheels 511 and 521 via linkages 513 or 523. The engine 510 may be powered by fuel stored in a fuel tank 550 that supplies fuel to the engine 510 via a fuel line 555. The vehicle 500 is equipped with a latch apparatus 530 that, in various embodiments, may include a latch apparatus 230 (FIGS. 2A-2C) or latch apparatus 330 (FIGS. 3A-3C). In various embodiments, the latch apparatus 530 is in communication with a vehicle control system 560. The vehicle control system 560 may integrate controls to permit local or remote activation of the latch apparatus 530 to control opening of a compartment hatch 590. As previously described with reference to FIG. 4, a speed sensor 570 (which may be part of the vehicle control system 560 or may be a separate device) communicates via a physical or communicative connection 580. Thus, for example, if the vehicle 500 is traveling in excess of the threshold speed when an emergency release (not shown in FIG. 5) is engaged, a secondary latch mechanism 260, 360 as described with reference to FIGS. 2A-2C and 3A-3C may prevent a primary latch from fully opening and thereby prevent the compartment hatch 590 from fully opening.

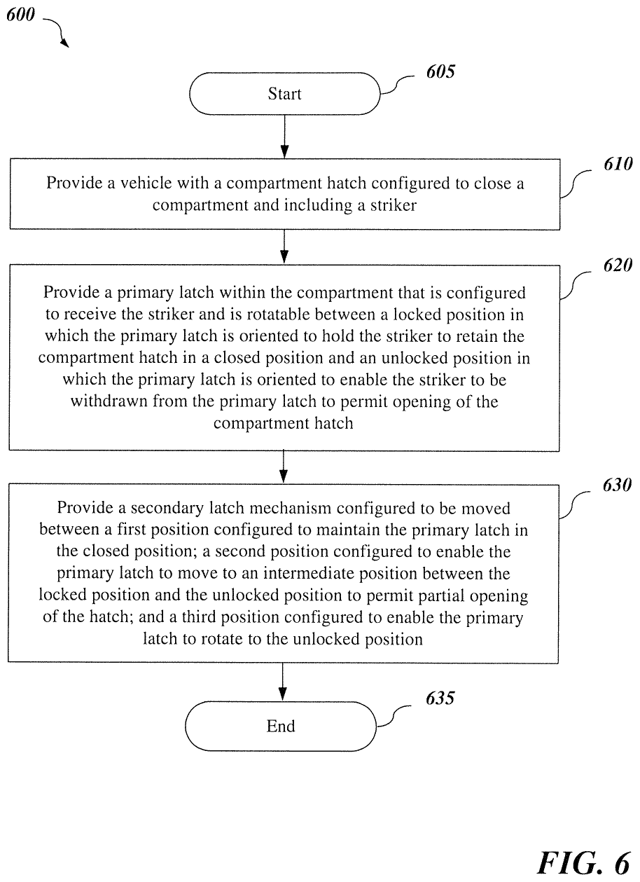

Referring to FIG. 6, an illustrative method 600 is provided for providing a vehicle with a latch apparatus for selectively controlling opening of a hatch compartment as described with reference to FIGS. 1, 2A-2C, and 3A-3C. The method begins at a block 605. At a block 610, a vehicle is provided with a compartment hatch that is configured to close a compartment and includes a striker. At a block 620, a primary latch is provided within the compartment that is configured to receive the striker and is rotatable between a locked position in which the primary latch is oriented to hold the striker to retain the compartment hatch in a closed position and an unlocked position in which the primary latch is oriented to enable the striker to be withdrawn from the primary latch to permit opening of the compartment hatch. At a block 630, a secondary latch mechanism is provided that is configured to be moved between: a first configuration configured to maintain the primary latch in the closed position; a second configuration configured to enable the primary latch to move to an intermediate position between the locked position and the unlocked position to permit partial opening of the hatch; and a third configuration configured to enable the primary latch to rotate to the unlocked position. The method 600 ends at a block 635.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (for example “configured to”) generally encompass active-state components and/or inactive-state components and/or standby-state components, unless context requires otherwise.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. It will be understood by those within the art that, in general, terms used herein, and especially in the appended claims (for example, bodies of the appended claims) are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

While the disclosed subject matter has been described in terms of illustrative embodiments, it will be understood by those skilled in the art that various modifications can be made thereto without departing from the scope of the claimed subject matter as set forth in the claims.

It will be appreciated that the detailed description set forth above is merely illustrative in nature and variations that do not depart from the gist and/or spirit of the claimed subject matter are intended to be within the scope of the claims. Such variations are not to be regarded as a departure from the spirit and scope of the claimed subject matter.

What is claimed is:

1. An apparatus comprising:
a primary latch that defines a slot configured to receive a striker extending from a compartment hatch and that is rotatable between a locked position in which the slot is oriented to hold the striker to retain the compartment hatch in a closed position, an intermediate position in which the slot is oriented to enable movement of the striker to permit partial opening of the compartment hatch, and an unlocked position in which the slot is oriented to enable the striker to be withdrawn from the slot to permit opening of the compartment hatch; and
a secondary latch mechanism configured to be moved between:
a first configuration configured to maintain the primary latch in the locked position;
a second configuration configured to enable the primary latch to rotate to and be maintained in the intermediate position; and
a third configuration configured to enable the primary latch to rotate to the unlocked position.

2. The apparatus of claim 1, wherein the secondary latch mechanism comprises:
a first latch member configured to prevent the primary latch from rotating out of the locked position when the secondary latch mechanism is in the first configuration and to not prevent rotation of the primary latch when the secondary latch mechanism is not in the first configuration; and
a second latch member configured to prevent the primary latch from rotating out of the intermediate position when the secondary latch mechanism is in the second configuration and to not prevent rotation of the primary latch when the secondary latch mechanism is not in the second configuration.

3. The apparatus of claim 2, wherein a release is disposable in a compartment defined by the compartment hatch in the closed position and is mechanically coupled to the first latch member so that activating the release moves the secondary latch mechanism from the first configuration to the second configuration.

4. The apparatus of claim 3, further comprising an actuator coupled with the second latch member and configured to selectively move the secondary latch mechanism into the third configuration by moving the second latch member, wherein the actuator moves the second latch member responsive to a signal that a vehicle equipped with the compartment hatch is traveling at or below a threshold speed and responsive to activation of the release.

5. The apparatus of claim 4, further comprising an additional actuator coupled with the first latch member, wherein the actuator and the additional actuator are configured to selectively move the secondary latch mechanism into the third configuration by the actuator moving the second latch member and the additional actuator moving the first latch member, wherein the actuator and the additional actuator are responsive to an external trigger.

6. The apparatus of claim 2, wherein:
the first latch member comprises a first pawl latch, wherein when the secondary latch mechanism is in the first configuration, the first pawl latch is rotatably oriented to engage a first notch on the primary latch to prevent rotation of the primary latch out of the locked position; and
the second latch member comprises a second pawl latch, wherein when the secondary latch mechanism is in the second configuration, the second pawl latch is rotatably oriented to engage a second notch on the primary latch to prevent rotation of the primary latch out of the intermediate position.

7. The apparatus of claim 6, further comprising a slidable linkage coupling the first pawl latch and the second pawl latch, configured such that the first pawl latch is independently rotatable to disengage from the first notch without rotating the second pawl latch but rotation of the second pawl latch to disengage from the second notch on the primary latch also rotates the first pawl latch to disengage from the first notch.

8. The apparatus of claim 7, further comprising an actuator coupled with the second pawl latch and configured to selectively move the secondary latch mechanism into the third configuration by rotating the second pawl latch to disengage from the second notch on the primary latch, thereby rotating the first pawl latch to disengage from the first notch via the slidable linkage, wherein the actuator is responsive to an external trigger to open the compartment hatch.

9. A vehicle comprising:
a vehicle body that defines at least one compartment closable by a compartment hatch;
a primary latch that defines a slot configured to receive a striker extending from the compartment hatch and that is rotatable between a locked position in which the slot is oriented to hold the striker to retain the compartment hatch in a closed position, an intermediate position in which the slot is oriented to enable movement of the striker to permit partial opening of the compartment hatch, and an unlocked position in which the slot is oriented to enable the striker to be withdrawn from the slot to permit opening of the compartment hatch; and
a secondary latch mechanism configured to be moved between:
a first configuration configured to maintain the primary latch in the locked position;
a second configuration configured to enable the primary latch to rotate to and be maintained in the intermediate position; and
a third configuration configured to enable the primary latch to rotate to the unlocked position.

10. The vehicle of claim 9, wherein the secondary latch mechanism comprises:
a first latch member configured to prevent the primary latch from rotating out of the locked position when the secondary latch mechanism is in the first configuration and to not prevent rotation of the primary latch when the secondary latch mechanism is not in the first configuration; and
a second latch member configured to prevent the primary latch from rotating out of the intermediate position when the secondary latch mechanism is in the second configuration and to not prevent rotation of the primary latch when the secondary latch mechanism is not in the second configuration.

11. The vehicle of claim 10, wherein a release is disposable in a compartment defined by the compartment hatch in the closed position and is mechanically coupled to the first latch member so that activating the release moves the secondary latch mechanism from the first configuration to the second configuration.

12. The vehicle of claim 11, further comprising an actuator coupled with the second latch member and configured to selectively move the secondary latch mechanism into the third configuration by moving the second latch member, wherein the actuator moves the second latch member responsive to a signal that a vehicle equipped with the compartment hatch is traveling at or below a threshold speed and responsive to activation of the release.

13. The vehicle of claim 12, further comprising an additional actuator coupled with the first latch member, wherein the actuator and the additional actuator are configured to selectively move the secondary latch mechanism into the third configuration by the actuator moving the second latch member and the additional actuator moving the first latch member, wherein the actuator and the additional actuator are responsive to an external trigger.

14. The vehicle of claim 12, wherein:
the first latch member comprises a first pawl latch, wherein when the secondary latch mechanism is in the first configuration, the first pawl latch is rotatably oriented to engage a first notch on the primary latch to prevent rotation of the primary latch out of the locked position; and
the second latch member comprises a second pawl latch, wherein when the secondary latch mechanism is in the second configuration, the second pawl latch is rotatably oriented to engage a second notch on the primary latch to prevent rotation of the primary latch out of the intermediate position.

15. The vehicle of claim 12, further comprising a slidable linkage coupling the first pawl latch and the second pawl latch, configured such that the first pawl latch is independently rotatable to disengage from the first notch without rotating the second pawl latch but rotation of the second pawl latch to disengage from the second notch on the primary latch also rotates the first pawl latch to disengage from the first notch.

16. The vehicle of claim 15, wherein the actuator is responsive to an external trigger to open the compartment hatch to cause the actuator to move the second latch member into the third position and to cause the slidable linkage to move the first latch member into the second position.

17. A method comprising:
providing a vehicle with a compartment hatch configured to close a compartment and comprising a striker;
providing a primary latch within the compartment that is configured to receive the striker and is rotatable between a locked position in which the slot is oriented to hold the striker to retain the compartment hatch in a closed position, an intermediate position in which the slot is oriented to enable movement of the striker to permit partial opening of the compartment hatch, and an unlocked position in which the slot is oriented to enable the striker to be withdrawn from the slot to permit opening of the compartment hatch; and
providing a secondary latch mechanism configured to be moved between:
a first configuration configured to maintain the primary latch in the closed position;
a second configuration configured to enable the primary latch to move to an intermediate position between the locked position and the unlocked position to permit partial opening of the hatch; and
a third configuration configured to enable the primary latch to rotate to the unlocked position.

18. The method of claim 17, further comprising:
configuring a first latch member of the secondary latch mechanism to prevent the primary latch from rotating out of the locked position when the secondary latch mechanism is in the first configuration and to not prevent rotation of the primary latch when the secondary latch mechanism is not in the first configuration; and
configuring a second latch member of the secondary latch mechanism to prevent the primary latch from rotating out of the intermediate position when the secondary latch mechanism is in the second configuration and to not prevent rotation of the primary latch when the secondary latch mechanism is not in the second configuration.

19. The method of claim 18, further comprising providing a release disposable in a compartment closable by the compartment hatch and mechanically coupled to the first latch member so that activating the release moves the secondary latch mechanism to the second position to permit partial opening of the compartment hatch.

20. The method of claim 19, further comprising configuring the second latch member to respond to a speed of a vehicle in which the compartment is comprised and preventing the second latch member from moving to the third configuration responsive to activation of the release until the vehicle is traveling at or below a threshold speed responsive to activation of the release.
